(19) United States
(12) Patent Application Publication
(10) Pub. No.: US 2008/0083842 A1
(43) Pub. Date: Apr. 10, 2008

(54) Nozzle strip for textile processing

(75) Inventor: Gunther Buchle, Bad-Waldsee (DE)

Correspondence Address: FITCH, EVEN, TABIN & FLANNERY, P. O. BOX 18415, WASHINGTON, DC, 20036, US

(73) Assignee: Groz-Beckert KG, Albstadt (DE)

(21) Appl. No.: 11/907,036

(22) Filed: Oct. 9, 2007

(30) Foreign Application Priority Data
Oct. 6, 2006 (DE) 10 2006 047 731.6

(51) Int. Cl. B05B 1/14

(52) U.S. Cl. 239/566

(57) ABSTRACT

A nozzle bar used for the water-jet compacting of a fibrous web has an opening on the side facing the fibrous web into which a nozzle strip (5) can be inserted. This nozzle strip is provided with at least one row of nozzle openings (6) for generating parallel water jets that are focused onto the fibrous web and function to compact the fibrous web. The nozzle strip (5) is formed with martensitic hardened steel.

### CROSS REFERENCE TO RELATED APPLICATION

This application claims the priority of German Patent Application No. 10 2006 047 731.6, filed on Oct. 6, 2006, the subject matter of which, in its entirety, is incorporated herein by reference.

### BACKGROUND OF THE INVENTION

The invention relates to a nozzle strip for a nozzle row used for the textile processing, said strip having the features as disclosed in the preamble to claim 1.

The compacting of fibrous webs or fleece with the aid of water jets is known from practice. In the process, an arrangement of fibers with random orientation, e.g. a so-called fibrous web, is moved through underneath a nozzle bar provided with a nozzle strip that contains a plurality of individual nozzles. The nozzle diameter is 0.1 mm and the nozzles are arranged in a row, e.g. spaced apart at a distance of 0.635 mm to each other, wherein the row can extend up to 7 m in length. Fine jets of water are sprayed through the nozzle openings at a pressure of up to 200 bar and more, causing the individual filaments to be intertwined and form a felt pad or mat.

The rather large number of nozzle openings must be produced with the highest precision. The tolerances for the arrangement of the nozzle openings and the opening diameters frequently are expected to be less than 2 μm.

Since nozzle strips of this type are subject to corrosion caused by the water, they must be corrosion-resistant and are generally made from stainless steel having a degree of hardness below 46 HRC, which results in limited stability under load. Over time, the geometries of the nozzle openings change, causing a reduction in the quality of the water jet. In that case, the water jet can spray or atomize and form droplets before it hits the fibrous web, so that the fibrous web is no longer compacted in the desired way.

### SUMMARY OF THE INVENTION

Starting with the above, it is the object of the present invention to create an improved nozzle strip.

This object is solved with a nozzle strip made from a martensitic, hardened steel.

This type of steel can be hardened and contains martensite, which may have been formed during the hardening [tempering?] process. The stability under load for this type of steel exceeds 46 HRC and is, for example, in the range of 54 to 60 HRC. To achieve this stability under load, protective gas with a nitrogen component is fed in during the thermal treatment, as disclosed in the prior art such as in the DE 40 33 706. In the process, the nitrogen components penetrate the edge layer. The nozzle openings can be inserted into the steel strip either before or after the tempering. In particular, the nozzle openings can be produced with the desired high precision while using standard processing methods. The martensitic, hardened steel makes it possible to achieve a higher life expectancy for the nozzle strip than would be possible with nozzle strips made from stainless steel.

The hardened steel preferably is a high-alloy steel, which additionally and preferably can contain carbon. The type of steel used advantageously is X20Cr13, which can be hardened during a thermal treatment while still retaining for the most part its corrosion resistance. Alloyed steels are hardened at high temperatures (see DIN EN 10052 and the book entitled: “WÄRMEBEHANDLUNG DES STAHLS” [Heat Treatment of Steel] by Dr. Volker Läpple, published by the Publishing House Europa Lehrmittel). As a result of the higher hardness of the nozzle strip, the nozzle openings retain their shape, especially at the inflow side, thereby ensuring a high-quality water jet over a long period of time.

Additional details and advantageous embodiments are the subject matter of the drawing, the specification, or the claims. The drawing contains an exemplary embodiment of the invention.

### BRIEF DESCRIPTION OF THE DRAWINGS

FIG. 1 is a schematic frontal view of a nozzle bar for compacting a fibrous web.

FIG. 2 is nozzle strip inserted into the nozzle bar and shown in a view from above.

FIG. 3 shows the nozzle strip according to FIG. 2, shown as a detailed sectional view in longitudinal direction.

### DETAILED DESCRIPTION OF THE INVENTION

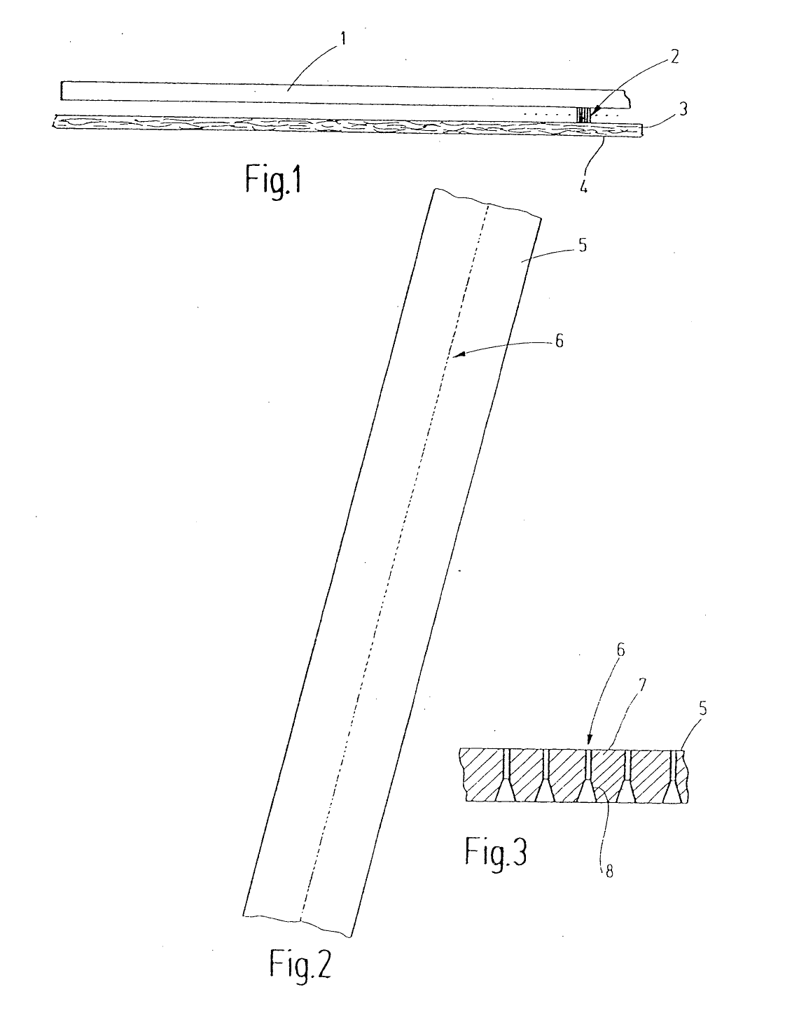

FIG. 1 illustrates a nozzle bar 1 for generating a water-jet curtain of individual sharply focused water jets 2 for the compacting of a textile fibrous web 3. The fibrous web 3 is held in place on a support 4 and is hit by the water jets once it comes to rest under the nozzle bar 1. In the process, the water jets 2 penetrate the fibrous web 3 and intertwine and mix up the individual fibers.

The nozzle bar 1 contains a nozzle strip 5 of sheet steel, which is provided with one or several rows of nozzle openings 6. All nozzle openings 6 are arranged, for example, in a straight line that extends over the complete length of the approximately 25 mm wide and up to 7 m long nozzle strip 5. However, the nozzle openings 6 can also occupy only a partial area, e.g. the perforated region of a nozzle strip 5. The diameters for the individual nozzle openings range from 80 μm up to 200 μm while the density of the nozzle openings can be 40 nozzle openings per inch (16 nozzle openings percentimeter). If several rows of nozzle openings are provided, the spacing between the rows ranges from 0.8 mm to 1.2 mm. With the exception of small tolerances of, for example less than 2 μm, the diameters for the nozzle openings are uniform along the nozzle strip 5.

FIG. 3 shows a longitudinal section through the nozzle strip 5. The nozzle openings 6 are uniform as shown with the example in FIG. 3. Depending on the product requirements for the fibrous web to be produced, the nozzle openings 6 can have different shapes and dimensions. On the inflow side, the individual nozzle openings are provided with a cylindrical section 7 and on the outflow side with a funnel-shaped, e.g. conical, section 8. The transitions between the sections 7, 8 can be smooth and thus without edges.

The nozzle strip 5 consists of martensitic hardened steel, for example X20Cr13. This type of steel can be hardened and is for the most part corrosion resistant. The corrosion-resistance is furthermore influenced only insignificantly by the thermal treatment and is retained. The martensitic structure can be viewed under a micrograph, for example with a suitable enlargement of 1:200. The steel preferably does not contain any or few austenite-forming agents such as nickel. In the edge region or in the surface region, the martensitic structure is enriched with nitrogen.

When the nozzle bar 1 is operational, water under pressure of between 30 bar and 200 bar, in a few cases more than 200 bar, is present at the inflow side of the nozzle strip 5, which is followed by the cylindrical sections 7 of the nozzle openings 6. As a result, water jets are generated in the cylindrical sections 7 of the nozzle openings 6, which freely flow from the funnel-shaped sections 8 and shoot through the air over a distance ranging from a few millimeters to several centimeters without disintegrating into individual droplets. The water jets hit the fibrous web 3 before they are atomized and effect the compacting therein. The quality of the generated water jet and its effect with respect to the reorganization and intertwining of the fibers substantially depends on the precision of the geometry for the nozzle openings 6. By using corrosion-resistant, martensitic steel, the geometry of the nozzle openings 6 does not substantially worsen even after longer periods of operation for the nozzle bar 1, so that the jet quality is retained over a long period of time. In particular the cylindrical geometry of the cylindrical sections is for the most part retained.

For specific application cases, the water present under pressure at the nozzle strip 5 can be present at the side of the nozzle strip 5 that has the funnel-shaped sections 8, which then form intake openings for the water that is subsequently focused during its further course through the cylindrical sections 7. Otherwise, a nozzle strip used in this manner operates in the same way as previously described.

A nozzle bar for the water-jet compacting of a fibrous web 3 is provided on the side facing the fibrous web 3 with an opening for inserting a nozzle strip 5. This nozzle strip contains at least one row of nozzle openings 6 for generating parallel-arranged water jets 2, which are directed toward the fibrous web 3 and function to compact the fibrous web. The nozzle strip 5 consists of martensitic hardened steel having a surface with a high corrosion resistance.

It will be appreciated that the above description of the present invention is susceptible to various modifications, changes and adaptations, and the same are intended to be comprehended within the meaning and range of equivalents of the appended claims.

Reference Number List
1 nozzle bar
2 water jets
3 fibrous web
4 support
5 nozzle strip
6 nozzle openings
7, 8 sections

1. A nozzle strip (5) for a nozzle bar used for the processing of textiles, in particular for the production of fibrous webs through the compacting with water jets,
comprising a steel strip section provided with a plurality of nozzle openings (6),
characterized in that
the steel strip section is composed of martensitic hardened steel with a strength higher than 46 HRC and nitrogen components in the edge region.

2. The nozzle strip according to claim 1, characterized in that the steel is thermally hardened.

3. The nozzle strip according to claim 1, characterized in that the hardness value of the steel exceeds 53 HRC.

4. The nozzle strip according to claim 1, characterized in that the hardness value of the steel exceeds 50 HRC.

5. The nozzle strip according to claim 1, characterized in that the steel is a high-alloy steel.

6. The nozzle strip according to claim 1, characterized in that the steel has carbon components.

7. The nozzle strip according to claim 1, characterized in that the type of steel is X20Cr13.

8. The nozzle strip according to claim 1, characterized in that the steel has a partially austenitic and in addition also a martensitic structure.

9. The nozzle strip according to claim 1, characterized in that the nozzle openings (6) have a cylindrical section (7) on the inflow side, which is followed by a funnel-shaped, expanded section (8).
